(19) United States
(12) Patent Application Publication
(10) Pub. No.: US 2012/0312146 A1
(43) Pub. Date: Dec. 13, 2012

(54) Interface Adapter for Installation of a Standard Magnetic Pickup into an Acoustic Guitar Sound Hole

(76) Inventor: Benjamin Randal Bekerman, Arlington, TX (US)

(21) Appl. No.: 13/158,387

(22) Filed: Jun. 11, 2011

(51) Int. Cl. G10H 3/18

(52) U.S. Cl. 84/726

(57) ABSTRACT

The interface device provides a means to install a standard magnetic pickup into the sound hole of an acoustic guitar in a manner which employs the use of a commercially available feedback reduction device. The interface mounting device provides the ability to use standard magnetic guitar pickups with an acoustic guitar that would normally require a special purpose guitar pickup. Further this interface mounting device provides a means to install the standard magnetic guitar pickup in a manner that is both secure during its operation, is adjustable to fit personal taste, is totally removable, and does not permanently affect the underlying acoustic guitar.

### CROSS REFERENCE TO RELATED APPLICATIONS

The present application is related to U.S. Pat. No. 4,394,830, issued Jul. 26, 1983, for FEEDBACK REDUCER FOR AN ACUSTIC ELECTRIC GUITAR, by Paul J. Damisno, Manchester, Conn.

The present application is related to U.S. Pat. No. 5,883,322, issued Mar. 16, 1999, for FEEDBACK MINIMIZING DEVICE, by Michael R. Baker, Minden, Nev.

| | |
|---|---|
| FEDERALLY SPONSORED RESEARCH | Not Applicable |
| SEQUENCE LISTING OR PROGRAM | Not Applicable |
| US CLASS | 84/267; 84/453; 84/725 |
| FIELD OF SEARCH | 84/267, 453, 723, 725, 743 |
| BACKGROUND - FIELD | |

### BACKGROUND

1. Field

This interface device application relates to the field of acoustic guitars, specifically to where the user requires the capability to install a standard magnetic pickup into the sound hole of said acoustic guitar.

2. Prior Art

The use of a large generic class of standard magnetic pickups are not suitable for use with an acoustic guitar because there is no convenient way to mount these pickups within the sound hole of the guitar. The problem is, how does someone install one of these standard magnetic pickups, many of which are of high quality, relatively low-priced, and available to suit many individual tastes, into the sound hole of an acoustic guitar?

Currently, mounting a magnetic pickup to an acoustic guitar has been accomplished via a customized arrangement to match a particular pickup configuration. The two patents referenced in this application provide methods of mounting unique magnetic pickups into the sound hole of an acoustic guitar.

The device contained in the '322 patent is of this variety, but is limited in that it will only accept specific magnetic pickups without further modification to the feedback reduction device. Whereas the interface device discussed herein provides an interface mounting adapter that enables the ability to mount a wide variety of commercially available magnetic guitar pickups without requiring modification to the mounting adapter, the feedback reduction device, or the acoustic guitar. Further this earlier invention had the restriction of not being able to allow individualized rotational adjustment of the pickup which is a highly desirable feature available with the design put forth herein.

Another approach to mounting a magnetic pickup to an acoustic guitar sound hole is provided in U.S. Pat. No. '830. One of the embodiments of this '830 patent includes a magnetic pickup that has been custom installed into the sound hole plug. The method of mounting this specific magnetic pickup into the guitar sound hole results in a configuration that is inflexible once a particular pickup location is selected.

Both of these earlier devices, U.S. Pat. Nos. '830 and '322 contain feedback reduction devices that will accept a custom magnetic pickup which is installed into the feedback reduction device that goes into the acoustic guitar sound hole. However, the shortfall of both of these earlier devices is that they will not accept a range of generic standard magnetic pickups. Neither do these earlier devices provide an easy method for rotational adjustment of the pickup within the sound hole relative to the fixed location of the strings.

Both the ability to accept generic standard magnetic pickups, and the ability to allow for precision adjustment of the location of the pickup relative to the fixed location of the strings are the principal objectives of the current interface device disclosed herein.

### SUMMARY

The claimed invented device provides an interface mounting adapter which is used as a means to install a standard magnetic pickup into a sound hole of an acoustic guitar. In accordance with the embodiment described herein, the interface mounting adapter approach provides a significant advantage by providing the ability for the musician to easily install and remove a broad range of commercially available standard magnetic pickups without damage to the acoustic guitar.

### DRAWINGS

### Figures

A complete understanding of the present interface device may be obtained by reference to the accompanying drawings, when considered in conjunction with the subsequent, detailed description, in which:

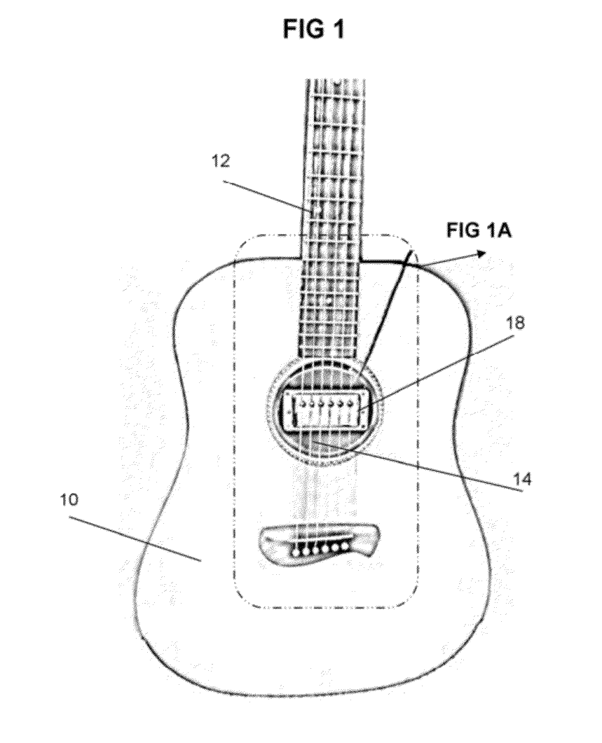

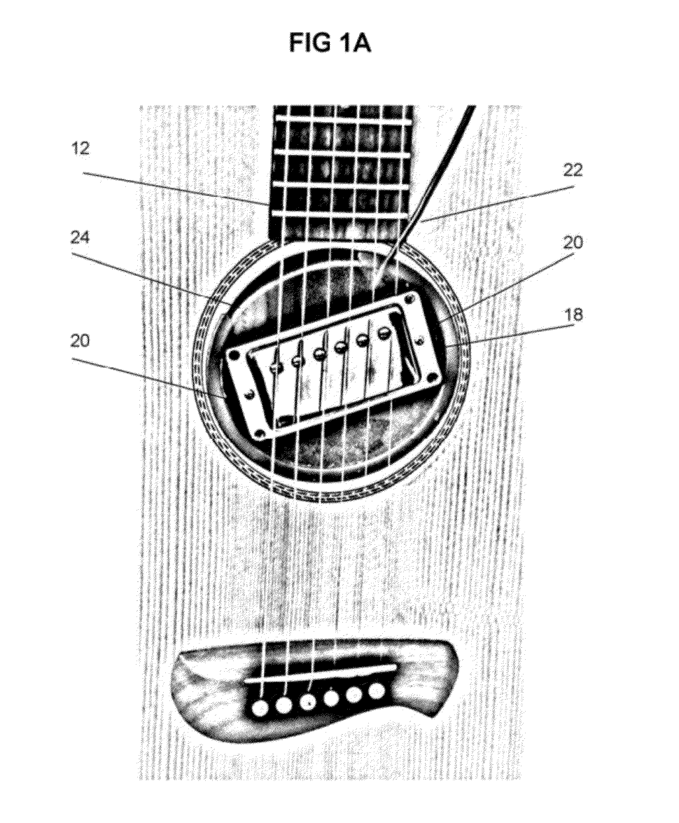

FIG. 1 is an overall top view of an acoustic guitar configured with the standard magnetic pickup mounted via the interface mounting adapter attached to the inner wall of the sound hole containing the feedback reduction device.

FIG. 1A is a closer overall top view showing the standard magnetic pickup installed via the interface mounting adapter installed in the sound hole of the guitar with the guitar strings situated above the standard magnetic pickup.

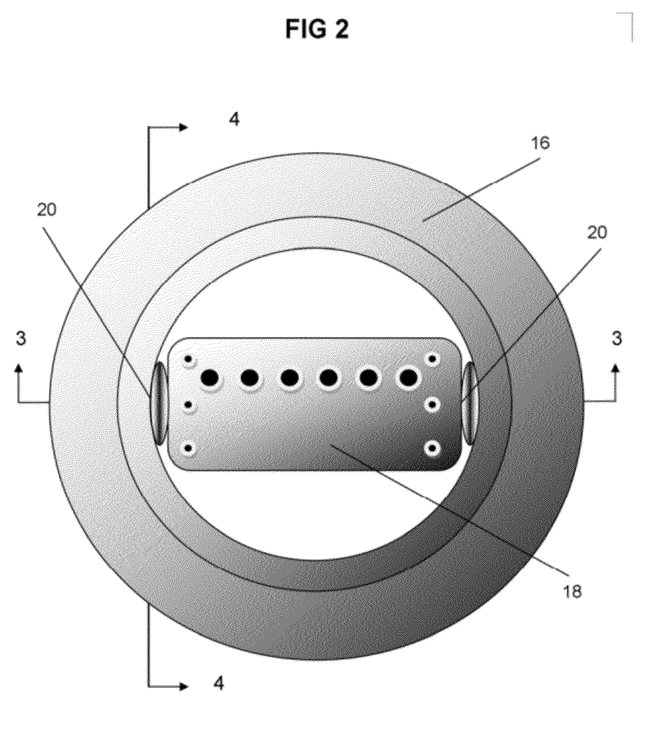

FIG. 2 is a top detail view of a feedback reduction device serving as the structure to support the interface device, the standard magnetic pickup interface mounting adapter attached to the inside circumference wall of the feedback reduction device.

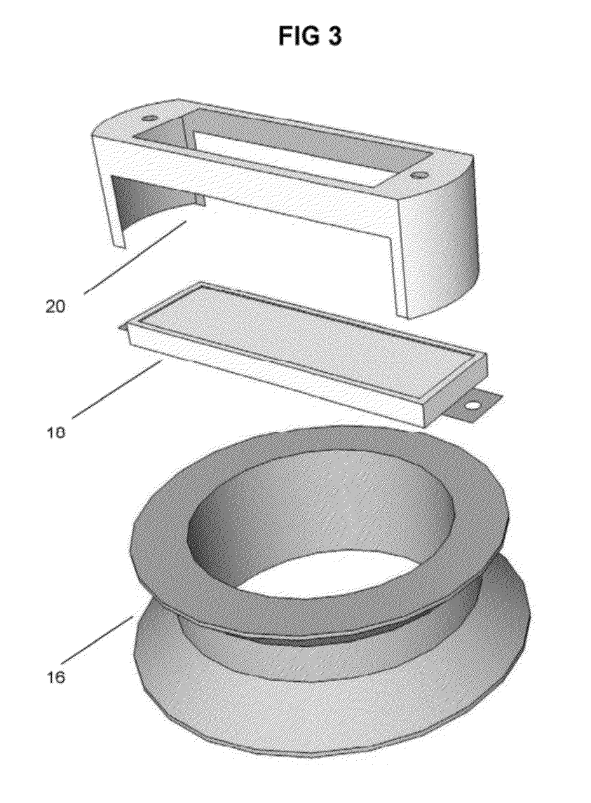

FIG. 3 is a perspective view showing the overall assembly of the claimed invention which is the interface mounting adapter. The interface mounting adapter captures the standard magnetic pickup and then this resulting combination is in turn inserted into the feedback reduction device.

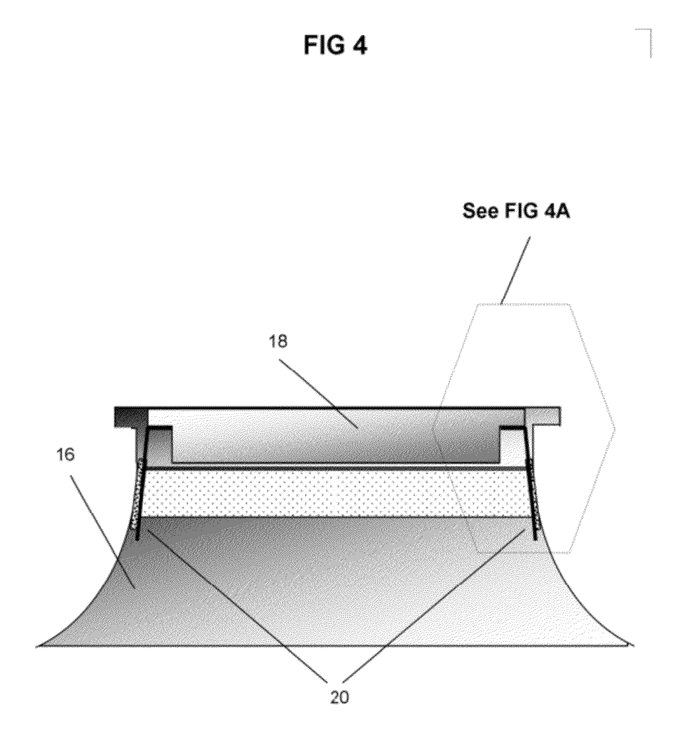

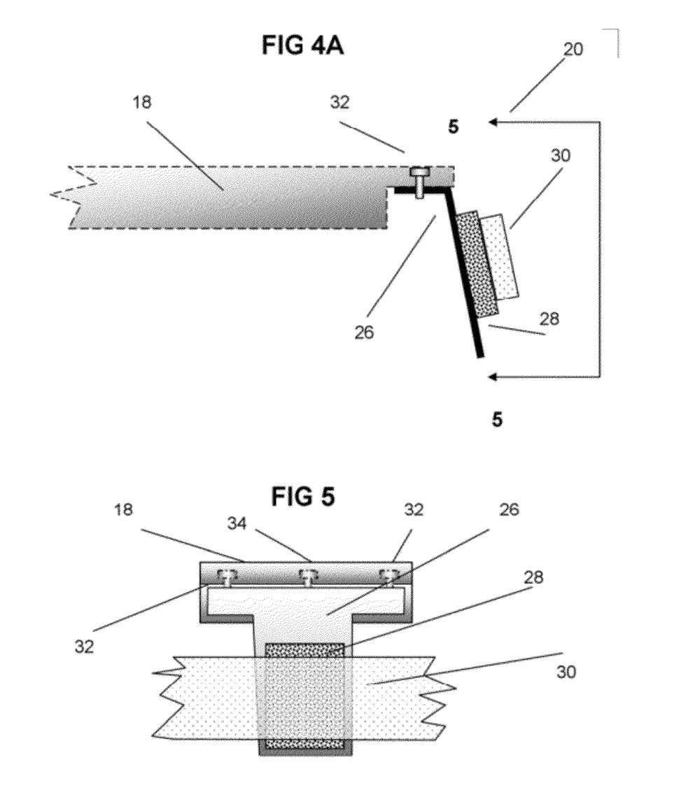

FIG. 4 is a center cut through view of a feedback reduction device with the standard magnetic pickup mounted within the feedback reduction device via the magnetic pickup interface mounting adapter whose elements are grouped and shown in FIG. 4A.

FIG. 4A is a closer detailed view of one side of the interface mounting adapter showing the elements which comprise the interface mounting adapter.

FIG. 5 is a front detail view of an interface mounting adapter showing one of the two support bracket hardware sets as installed to the standard magnetic pickup with the hook or loop fastener set which in turn connects the interface mounting adapter to the feedback reduction device inner wall via its hook or loop fastener mate.

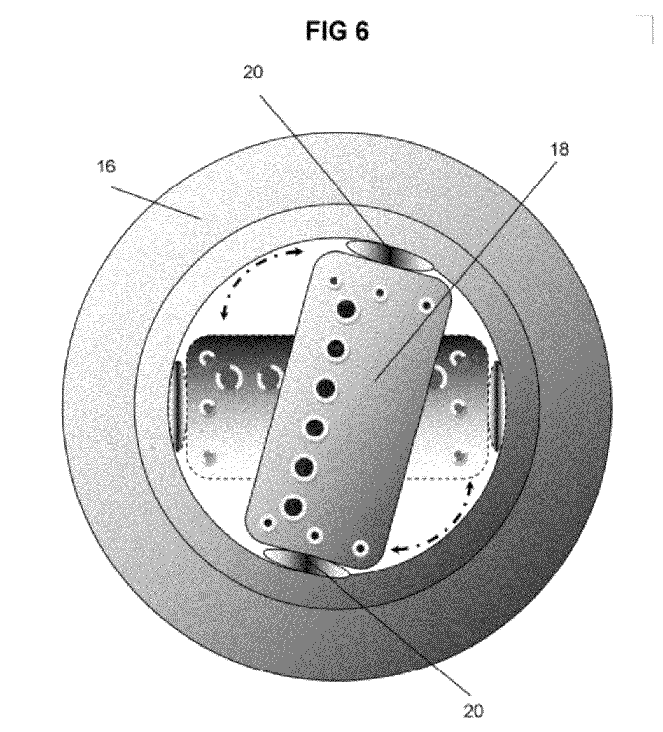

FIG. 6 is a top view of a standard magnetic pickup depicting that the pickup can be rotated within the feedback reduction device using the interface mounting adapter, thus allowing the user flexibility in achieving their personalized optimum configuration relative to the location of the fixed strings of the acoustic guitar.

### LIST OF REFERENCE NUMBERS

10 acoustic guitar
12 strings
14 sound hole
16 feedback reduction device
18 standard magnetic pickup
20 interface mounting adapter
22 pickup interface cable
24 sound hole with installed feedback reduction device
26 support bracket
28 hook or loop set
30 hook or loop mate
32 mounting hardware
34 pickup height adjusting screw

### DETAILED DESCRIPTION OF THE PREFERRED EMBODIMENT

Like elements and components will bear the same designations and numbering throughout the Figures.

FIG. 1 is an overall top view of an acoustic guitar 10 configured with the standard magnetic pickup 18 mounted via the interface mounting adapter 20 attached to the inner wall of the sound hole containing the feedback reduction device 24. The output of the standard magnetic pickup 18 is made available to external electronics via the pickup interface cable 22. Situated above the sound hole 14 are the guitar strings 12.

FIG. 1A is a closer overall top view showing the standard magnetic pickup 18 installed via the interface mounting adapter 20 installed in the sound hole 14 of the guitar 10 with the guitar strings 12 situated above the standard magnetic pickup 18. The interface mounting adapter 20 containing the standard magnetic pickup 18 on one end of the support bracket 26 assembly is then positioned within the interior of the sound hole 14 by connecting to the inner wall of the feedback reduction device 16. The output of the standard magnetic pickup 18 is made available to external electronics via the pickup interface cable 22. Located above the sound hole 14 are the guitar strings 12.

FIG. 2 is a top detail view of a feedback reduction device 16 serving as the structure to support the standard magnetic pickup via the interface device, the interface mounting adapter 20 attached to the inside circumference wall of the feedback reduction device 16. The interface mounting adapter 20 attaches to the feedback reduction device 16 via a hook or loop fastener set 28. This hook or loop fastener set 28 consists of a hook or loop set of materials which mate to each other. The hook or loop fastener set 28 can be easily separated from each other, repositioned, and re-fastened. The feedback reduction device 16 contains the hook or loop fastener mate 30 material which is installed along the inside circumference of the feedback reduction device 16.

FIG. 3 is a perspective view showing the overall assembly of the claimed invention which is the interface mounting adapter 20. The interface mounting adapter 20 captures the standard magnetic pickup 18 and then this resulting combination is in turn inserted into the feedback reduction device 16. One of the features of the interface mounting adapter is that it allows the use of a pickup height adjusting screw which is then used to precisely position the pickup in the up and down direction relative to the fixed position of the guitar strings. FIG. 3, specifically the interface mounting adapter 20 is the preferred configuration for the invention device claimed herein.

FIG. 4 is a center cut through view of a feedback reduction device 16 with the standard magnetic pickup 18 mounted within the feedback reduction device 16 via the interface mounting adapter 20. An alternative configuration for implementation of the interface mounting adapter 20 is shown by the combination of elements contained in the grouping shown in FIG. 4A. The interface mounting adapter 20 is a generic term for a group of components that perform the function of interfacing between the standard magnetic pickup 18 to the inner circular wall of the feedback reduction device 16. This group of components is further identified In FIG. 4A.

FIG. 4A is a closer detailed view of one side of the interface mounting adapter 20 showing its compositional elements when implemented in a discreet manner as shown. In this configuration the interface mounting adapter 20 consists of a group of components consisting of: a support bracket 26, a hook or loop fastener set 28 attachment material, its hook or loop fastener mate 30, mounting hardware 32 to connect the support bracket 26 to the standard magnetic pickup 18, and a pickup height adjusting screw 34 for the purpose of fine tuning the height position of the standard magnetic pickup 18 to the desired location within the sound hole with feedback reduction device 24.

The pickup height adjusting screw 34 allows the pickup to be precisely positioned in the up and down direction relative to the fixed position of the guitar strings 12. There are two interface mounting adapters attached to the standard magnetic pickup 18. Each interface mounting adapter 20 is located on each end of the standard magnetic pickup 18 as shown in FIG. 5.

FIG. 5 is a front detail view of an interface mounting adapter 20 as implemented in a discrete component manner showing one of the two support bracket 26 hardware sets as installed to the standard magnetic pickup 18 with the hook or loop fastener set 28 which in turn connects the other end of the support bracket 26 to the feedback reduction device 16 inner wall via its hook or loop fastener mate 30.

The discrete component implementation methodology as shown in FIG. 5 contains a support bracket 26 with two threaded holes which connect the support bracket 26 to the standard magnetic pickup 18. There is a center screw which serves as a pickup height adjusting screw 34. The purpose of this pickup height adjusting screw 34 is to allow interface of the standard magnetic pickup 18 in a manner that will enable positioning of the pickup up and down relative to the support bracket 26 while the support bracket 26 remains stationary.

In the discrete implementations shown the support bracket 26 contains a hook or loop fastener set 28. One typical implementation for installation of the individual hook or loop fastener set 28 is to have one side that has an adhesive backing which allows one side of the hook or loop fastener set 28 to mount to the support bracket 26, while the other side [the hook or loop fastener mate 30] is adhesively mounted on the inner wall of the feedback reduction device 16.

The support bracket 26 is made such that it is picked up by two screws on the standard magnetic pickup 18. The hook or loop fastener set 28 that is attached to the feedback reduction device 16 is contained along an inner circumference of the feedback reduction device 16. These hook or loop fastener sets 28 are situated such that the hook or loop fastener 28 on the support bracket 26 can come in contact with the hook or loop fastener mate 30 on the inside of the feedback reduction device 16.

This hook or loop fastener set 28 attaching arrangement allows for the support bracket 26, with the standard magnetic pickup 18 to be rotated within the sound hole with feedback reduction device 24 to achieve personalized precision tuning of the standard magnetic pickup 18 relative to its position below the strings 12 of the acoustic guitar 10 in the rotational plane relative to the guitar strings 12.

The interface mounting adapter 20 in the preferred configuration is shown in FIG. 3 is of single piece construction. This interface mounting adapter 20 then captures the standard magnetic pickup 18 via two pickup height adjustment screws 34. The preferred configuration with the installed standard magnetic pickup 20 is then inserted into the feedback reduction device 16. In the preferred configuration the interface mounting adapter 20 is held in place to the feedback reduction device 16 via friction. However there are other implementation methods besides friction for positioning the interface mounting adapter to the inner wall of the feedback reduction device.

Since the feedback reduction device is flexible 16, the interface mounting adapter 20 can be either rigid or semi-flexible in order for the interface mounting adapter to be securely positioned on the inner circular wall of the feedback reduction device 16. The interface mounting adapter 20 can be made from metal such as stamped steel, or cast aluminum, or a molded plastic for example.

The discrete alternate implementation of the interface mounting adapter 20 consists of two support brackets 26 with mounting hardware 32 and hook or loop fastener set 28 on each side of the standard magnetic pickup 18. Each support bracket 26 is sufficiently flexible such that the portion of the support bracket 26 that comes in contact with the hook or loop fastener set 28 set can conform to the circular inner wall of the feedback reduction device 16 containing the hook or loop fastener mate 30 thus providing sufficient surface area for securing the standard magnetic pickup 18 with adapter inside the feedback reduction device 16.

FIG. 6 is a top view of a standard magnetic pickup 18 depicting that the pickup can be rotated within the feedback reduction device 16 using the interface mounting adapter 20, thus allowing the user flexibility in achieving their personalized optimum configuration relative to the location of the fixed strings 12 of the acoustic guitar 10.

For illustration purposes the standard magnetic pickup 18 is shown rotated 45° with respect to the referenced baseline location within the feedback reduction device 16. This realignment of the standard magnetic pickup 18 is enabled by the interface mounting adapter 20 which enables rotation of the standard dynamic pickup the entire 360° within the sound hole with feedback reduction device 24. The output of the standard magnetic pickup 18 is provided via the pickup interface cable 22 that then attaches to other electronic equipment external to the acoustic guitar 10.

The acoustic guitar 10 strings 12 that are used with the standard magnetic pickup 18 arrangement are of a magnetic variety which is commercially available. Normally acoustic guitars are equipped with a nylon type string material, however nylon type construction will not properly excite the standard magnetic pickup 18, therefore nylon type guitar strings 12 are not useful when using the standard magnetic pickup 18 configuration. There are a variety of metalized guitar strings 12 that will fit an acoustic guitar 10 and are suited for properly exciting the standard magnetic pickup 18.

The standard magnetic pickup 18 shown in the figures illustrate the use of a double coil type of pickup commercially known as a ‘Humbucker’. However single coil pickups are just as applicable to the use of this interface device. The difference in the interface mounting adapter 20 dimensions would need to be dimensioned slightly different between the two coil types since the single coil is narrower than the double coil standard magnetic pickup 18 configuration.

The use of the hook or loop set material is one implementation to attach the interface mounting adapter 20 to the inner feedback reduction device 16 wall. However other materials are just as applicable such as an appropriate metal strip on the inside of the feedback reduction device 16 wall with a magnet on the support bracket 26.

Also the adjustment of the standard magnetic pickup 18 inside the feedback reduction device 16 does not need to be continuous such as provided by a ribbon of hook or loop fastener set 28, but can be periodic such as discrete/individualized hook or loop fastener set 28 discs, hook or loop fastener squares, magnetic disks, or magnetic squares. The main idea with this interface device is to be able to interface a standard magnetic pickup 18 to an acoustic guitar 10.

Other attachment methods, as alternatives to the preferred method of friction, are also available to secure the interface mounting bracket, which is holding the standard magnetic pickup 18, to the inner wall of the feedback reduction device 16. These other securing implementations of the interface mounting adapter 20 to the inner circular wall of the feedback reduction device 16 would include methodologies such as the hook or loop fastener set 28, spring tension, snaps, pegs, or tape.

Since other modifications and changes will be apparent to those skilled in the art, the interface device is not considered limited to the example chosen for purposes of disclosure, and covers all changes and modifications which do not constitute departures from the spirit and scope of this magnetic pickup interface mounting device.

Having thus described the interface device, what is desired to be protected by this patent is provided in the subsequent claims section.

1. What I claim as my invention performs the function of an interface mounting adapter for use as a means to install a standard magnetic pickup into the sound hole of an acoustic guitar comprising:
a means for providing a mechanical attachment interface between a commercial standard magnetic pickup to the inside an acoustic guitar sound hole;
one end of the interface mounting bracket attaches to the standard magnetic pickup, while the other end of the interface mounting adapter attaches to the inner wall of a feedback reduction device which is located inside and attached to the guitar sound hole;
the interface mounting bracket provides a means for adjusting the height (distance of the magnetic pickup upper surface relative to the location of the fixed strings) of the standard magnetic pickup, as well as the rotational position of the pickup head in a plane that is parallel to the guitar strings as the pickup sets within the acoustic guitar sound hole.

2. An interface mounting adapter for providing a mechanical means of attachment enabling a means to install a standard magnetic pickup onto an acoustic guitar sound hole.
